(19) United States
(12) Patent Application Publication
(10) Pub. No.: US 2007/0175016 A1
(43) Pub. Date: Aug. 2, 2007

(54) Method and apparatus for removing and replacing components of an airplane

(75) Inventors: Michael W. Sievers, Renton, WA (US); Timothy A. George, Maple Valley, WA (US)

Correspondence Address: WILDMAN HARROLD ALLEN & DIXON, 225 WEST WACKER DRIVE, SUITE 2800, CHICAGO, IL, 60606, US

(73) Assignee: The Boeing Company

(21) Appl. No.: 11/346,475

(22) Filed: Feb. 2, 2006

(51) Int. Cl. B23P 11/00

(52) U.S. Cl. 29/525.01

(57) ABSTRACT

The invention relates to apparatus and methods to shore an airplane to facilitate the replacement of one or more airplane parts, such as an airplane's upper skin panels, lower skin panels, and/or window assemblies. In one aspect of the invention, a method is provided which comprises disposing at least one beam underneath an airplane floor structure, supporting the beam with at least one jack which extends through a hole in a lower skin of the airplane, and removing and replacing at least one airplane part.

### BACKGROUND OF THE INVENTION

Many existing shoring practices for repairing and/or replacing parts of an airplane require that body cradles be disposed against various portions of the airplane, and additionally require the use of horizontal stabilizing units. Often, due to airplane constraints, additional load bearing supports at other locations are not utilized. When lower fuselage skin panels are replaced, stabilizing beams are often extended through the airplane's windows to allow the cradles to be removed in order to gain access to the lower skin panels. During the replacement procedure the operator must, often in sequential order, disassemble the upper fuselage lap joints, disassemble the upper fuselage stringer attach points, replace the side window panels, and replace the lower fuselage skin panels. During this procedure, the upper panels often may not be replaced simultaneously with the lower panels. This process may be inefficient, difficult, timely, and/or costly.

An apparatus and method for use is needed which may solve one or more problems in existing shoring practices.

### SUMMARY OF THE INVENTION

In one aspect of the invention, a method is provided of shoring an airplane to facilitate the replacement of one or more airplane parts. The method comprises disposing at least one beam underneath an airplane floor structure, supporting the at least one beam with at least one jack, removing at least one airplane part, and replacing the at least one airplane part. At least a portion of the at least one jack extends through at least one hole in a lower skin of the airplane.

In another aspect of the invention, an airplane under the invention comprises at least one replaced airplane part. The at least one airplane part was replaced while at least one beam was temporarily disposed underneath an airplane floor structure. During that replacement, the at least one beam was supported by at least one jack which extended through at least one hole in a lower skin of the airplane.

In a further aspect of the invention, an apparatus is provided for shoring an airplane to facilitate the replacement of one or more airplane parts. The apparatus comprises at least one beam disposed underneath an airplane floor structure, and at least one jack supporting the at least one beam. At least a portion of the at least one jack extends through at least one hole in a lower skin of the airplane.

These and other features, aspects and advantages of the invention will become better understood with reference to the following drawings, description and claims.

### BRIEF DESCRIPTION OF THE DRAWINGS

FIG. 1 is a perspective, partial cut-away view of one embodiment of an apparatus under the invention;

FIG. 2 is a side, partial cut-away view of the apparatus of FIG. 1;

FIG. 3 is a side view of the airplane of FIG. 1 showing only the placement of cradles under the airplane; and

FIG. 4 is a top, partial cut-away view of the airplane of FIG. 1 showing only the placement of window beams extending across the airplane.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

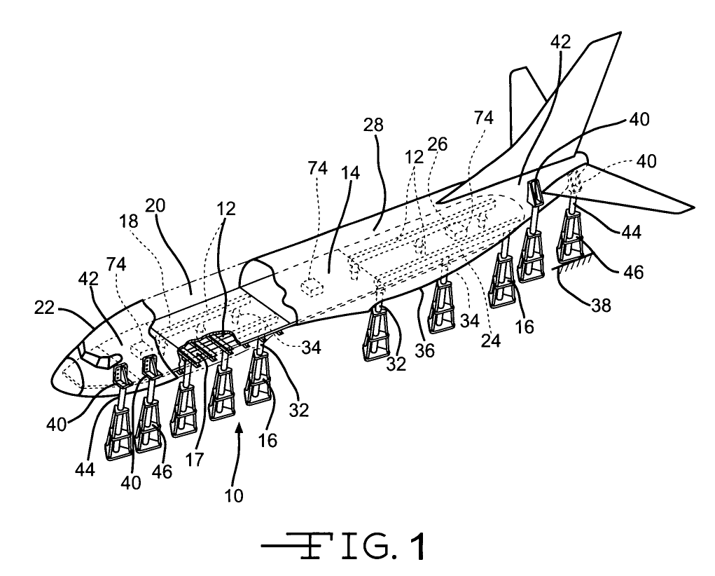

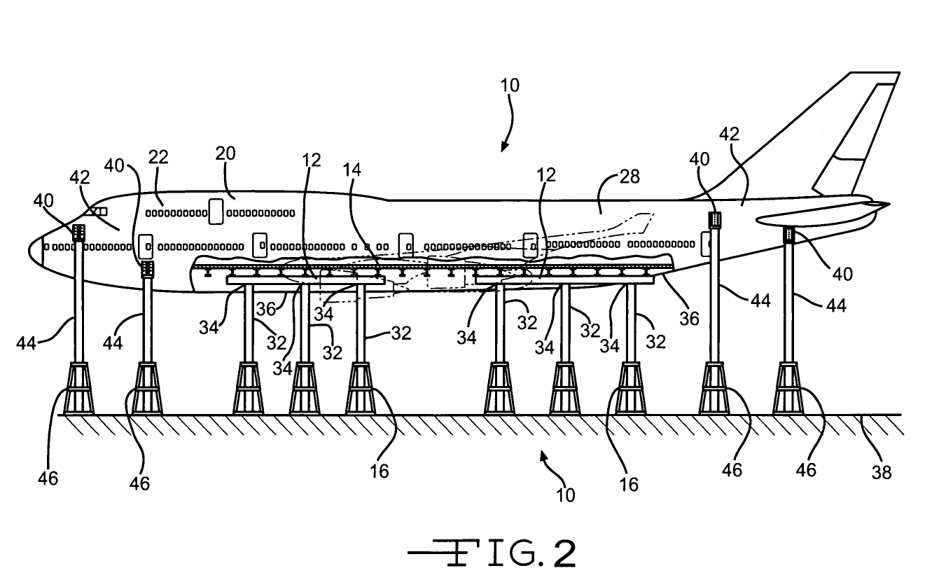

Generally, an apparatus under the present invention may be used to aid in shoring an airplane to facilitate the replacement of one or more airplane parts, such as an airplane's upper skin panels, lower skin panels, and/or window assemblies. As shown in FIGS. 1 and 2, in one embodiment of an apparatus under the invention to facilitate the replacement of one or more airplane parts, the apparatus 10 may include a plurality of beams 12 disposed underneath an airplane floor structure 14 within the airplane 22, and one or more jacks 16 supporting the beams 12. Two beams 17 and 18 may be disposed in a forward portion 20 of the airplane 22, and two beams 24 and 26 may be disposed in an aft portion 28 of the airplane 22. One or more of the beams 12 may comprise a plurality of discrete beam segments connected together to form an integral beam. The beam segments may be connected together through the use of bolts or other mechanisms known in the art. The beams 12 may be made of one or more varying materials such as aluminum and steel, and may be abutted and/or attached to the bottom of the airplane floor structure 14. In other embodiments, any number of varied material beams 12 may be used in differing shapes, sizes, locations, orientations, and configurations.

The jacks 16 may include one or more vertically extending support posts 32. At least a portion of the jacks 16, which may comprise support posts 32, may extend through one or more holes 34 in a lower skin 36 of the airplane 22. The jacks 16 may be supported by a ground surface 38 and support posts 32 may extend through one or more holes 34 in the airplane's lower skin 36 all the way to the beams 12 disposed within the airplane 22. The jacks 16 may be used to extend the support posts 32 upwardly in order to support the airplane 22 during the replacement of one or more airplane parts, and/or to raise the airplane 22 off the ground during a replacement procedure. Load cells may be used to distribute weight appropriately throughout the jacks 16 and/or beams 12. In one embodiment, two separate jacks 16 and support posts 32 may be utilized on each of two aft beams 24 and 26 and each of two forward beams 17 and 18.

The apparatus 10 may further include one or more body fittings 40 attached to an outer surface 42 of the airplane 22 to aid in shoring up the airplane during the replacement procedure. The body fittings 40 may comprise one or more members, such as plates, which are adapted to be attached to the airplane 22 through the use of bolts, or other mechanisms known in the art. The body fittings 40 may be made of one or more varying materials such as aluminum and steel, and may be attached to forward 20 and aft 28 outer surfaces 42 of the airplane 22. Support posts 44 may extend from jacks 46 on the ground surface 38 to the body fittings 40 attached to the airplane 22. The jacks 46 may be used to extend the support posts 44 upwardly in order to support the airplane 22 during the replacement of one or more airplane parts, and/or to raise the airplane 22 off the ground during a replacement procedure. Load cells may be used to distribute weight appropriately throughout the jacks 46 and/or body fittings 40. In one embodiment, four separate jacks 46, support posts 44, and body fittings 40 may be utilized on each of the nose and tail sections of the airplane 22. In other embodiments, any number of varied material body fittings 40 may be used in differing shapes, sizes, locations, orientations, and configurations.

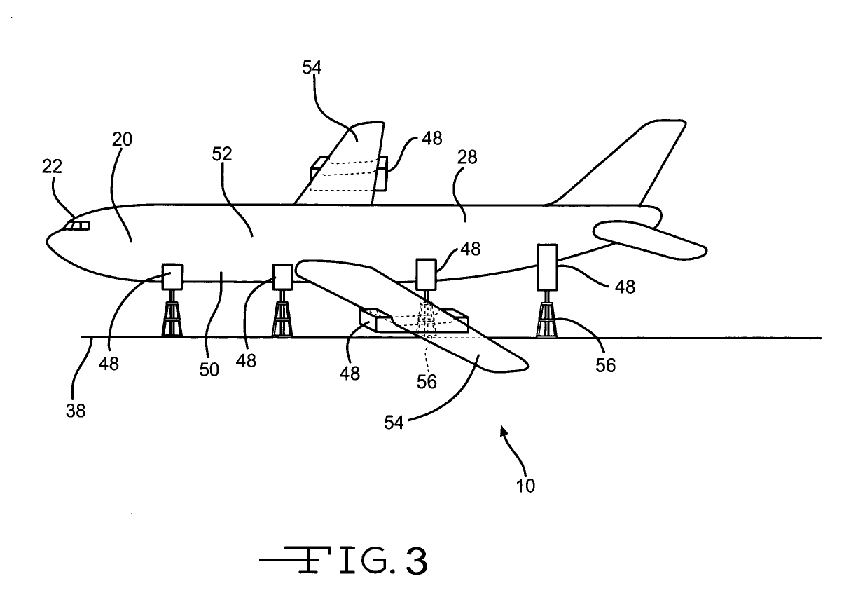

As shown in FIG. 3, the apparatus 10 may additionally include one or more cradles 48 disposed against a bottom outer surface 50 of the airplane 22 to shore up the airplane during the replacement procedure. The cradles 48 may comprise curved surfaces contoured to match the contour of the outer surface 50 of the airplane 22. In one embodiment, three cradles may be utilized for each wing, and four cradles may be utilized for the fuselage. The cradles 48 may be made of one or more varying materials such as aluminum and steel, and may be distributed throughout forward 20 and aft 28 portions of the fuselage 52 and over both wings 54 in order to evenly distribute the weight of the airplane 22 as dictated by procedures in Boeing's Structural Repair Manual (SRM). The cradles 48 may be connected to jacks 56 on the ground surface 38. The jacks 56 may be used to extend the cradles 48 upwardly in order to support the airplane 22 during the replacement of one or more airplane parts, and/or to raise the airplane 22 off the ground during a replacement procedure. Load cells may be used to distribute weight appropriately throughout the jacks 56 and/or cradles 48. In other embodiments, any number of varied material cradles 48 may be used in differing shapes, sizes, locations, orientations, and configurations.

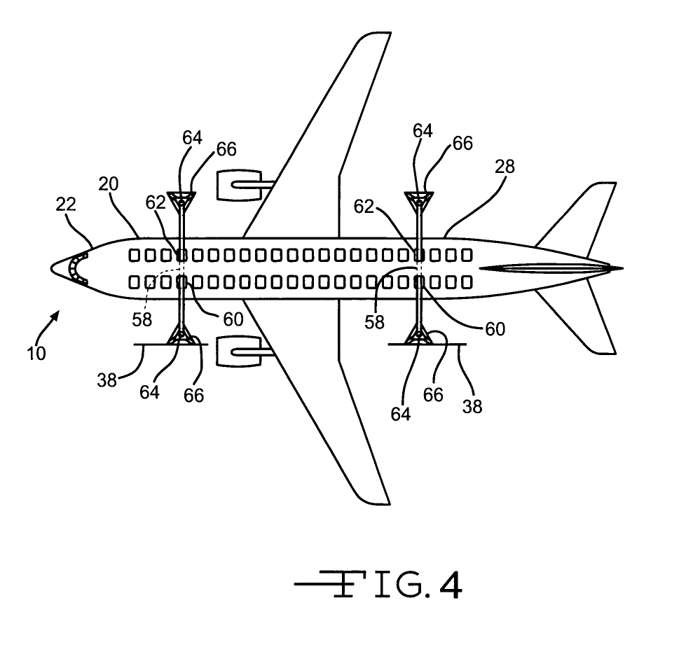

As shown in FIG. 4, the apparatus 10 may also include one or beams 58 extending within the airplane from one airplane window 60 to another airplane window 62 to aid in shoring up the airplane during the replacement procedure. In one embodiment, two beams 58 may be extended through windows forward of the wings, and another two beams 58 may be placed through windows aft of the wings. The beams 58 may be supported by one or more connected support structures 64, such as support posts 64 bolted to the beams 58, which extend from the beams 58 to the ground surface 38. The connected support structures 64 may be attached to jacks 66 on the ground surface 38. The beams 58 may be made of one or more varying materials such as aluminum and steel, and may be distributed throughout forward 20 and aft 28 portions of the airplane 22. The beams 58 may aid in supporting the airplane 22 as dictated by procedures in Boeing's Structural Repair Manual (SRM). Load cells may be used to distribute weight appropriately throughout the beams 58 and/or support structures 64. In other embodiments, any number of varied material beams 58 may be used in differing shapes, sizes, locations, orientations, and configurations.

In a varying embodiment of the invention, an airplane 22 may be provided having one or more replaced airplane parts, which may comprise one or more replaced upper skin panels, lower skin panels, window assemblies, and/or other types of replaced airplane parts. The one or more replaced airplane parts may have been replaced while one or more beams 12 were temporarily disposed underneath a floor structure 14 of the airplane 22. During that time, the one or more beams 12 may have been abutted and/or attached to the airplane floor structure 14, one or more body fittings 40 may have been attached to the airplane 22, one or more cradles 48 may have been disposed against the airplane 22, and/or one or more beams 58 may have extended between airplane windows 60 and 62. At this same time, one or more jacks 16 may have extended through one or more holes 34 in a lower skin 36 of the airplane 22 in order to support the one or more beams 12. The one or more jacks 16 may have included one or more support posts 32 extending through the one or more holes 34 in the airplane's lower skin 36.

During one embodiment of a shoring procedure under the invention to facilitate the replacement of one or more airplane parts, the interior of an airplane 22 may be prepped prior to replacing the parts. The prepping may comprise the removal of the airplane's galley, lavatories, cabin interior, cabin liners, cargo compartment liners, and/or any other interior items which may make the replacement procedure more difficult. The airplane 22 may be jacked up away from the ground to a level position utilizing jacks 74, which may include jacks 74 distributed throughout the airplane's nose, tail, and/or other locations. In one embodiment, the jacks 74 may include one jack on each wing, one jack on the airplane's nose, and one jack on the airplane's tail. During jacking of the airplane, Boeing procedure 737-300/-400/-500 AMM 07-51-51, or other jacking procedures known in the industry, may be utilized. Body fittings 40 may then be attached to an outer surface 42 of the airplane 22, such as at forward 20 and aft 28 locations of the airplane 22. Preferably, a plurality of body fittings 40 are bolted to a forward portion of the airplane 22 and a plurality of body fittings 40 are bolted to an aft portion of the airplane 22. Support posts 44 may be extended from jacks 46 on the ground surface 38 to the body fittings 40 to further jack-up and support the airplane 22. Load cells may be utilized to distribute weight appropriately throughout the jacks 46 and/or body fittings 40. The maximum load allowable on each support post 44 is preferably not exceeded while maintaining the level position of the airplane 22.

After the body fittings 40 and support posts 44 are in place, the nose and tail jacks 74 may be removed from their positions against the airplane 22. Wing and body cradles 48 may be disposed against the airplane 22 as described in Boeing procedure 737-300 SRM 51-50-02, which describes the positioning of the cradles 48 when the airplane 22 is initially built. In one embodiment, three cradles may be utilized for each wing, and four cradles may be utilized for the fuselage. In other embodiments, varying numbers of cradles in various locations may be utilized. The cradles 48 may be connected to jacks 56 on the ground surface 38. The jacks 56 may be used to extend the cradles 48 upwardly in order to further support the airplane 22. Load cells may be used to distribute weight appropriately throughout the jacks 56 and/or cradles 48. The engines may be removed or their weight supported as per Boeing procedure 737-300 SRM. One or more holes 34 may be cut in one or more lower skin panels 36 of the airplane 22. Preferably, multiple holes 34 are distributed throughout the lower surface 36 of the airplane. The hole diameters may be in the range of six inches and may be centered between stringers and frames of the airplane 22. In other embodiments, the holes 34 may be of varying sizes, orientations, configurations, and locations. One or more support posts 32 may be extended from jacks 16 on the ground through the one or more holes 34 in the lower skin panels 36 of the airplane 22. Preferably, multiple support posts 32 are used, and one support post 32 extends through each hole 34 distributed throughout the lower surface 36 of the airplane 22. Preferably, at least a 0.12 inch minimum clearance exists between the skin panel access holes 34 and the support posts 32.

One or more beams 12 may be inserted through the cargo bay of the airplane 22 and underneath and/or against an airplane floor structure 14. The beams 12 may be inserted into the cargo bay as separate discrete beam segments and then attached together, using bolts or other known mechanisms, to form one or more integral beams 12. The beams 12 may be placed in stable positions rested on top of the support posts 32 and may be abutted, in substantially parallel positions, against the bottom of the floor structure 14 of the airplane 22. In other embodiments, the beams may be placed in various configurations. Preferably, the beam support posts 32 are located substantially midway between the beams of the airplane floor structure 14. Preferably, the beams 12 are located so that they extend substantially beyond the forward 20 and aft 28 most support posts 32 distributed throughout the airplane 22. In one embodiment, two beams 12 may be disposed in a forward portion 20 of the airplane 22, and two beams 12 may be disposed in an aft portion 28 of the airplane 22. Preferably, each beam 12 is supported by two or more support posts 32. In other embodiments, a varying number of beams 12 may be utilized in varying locations. Preferably, the beams 12 are located in locations and orientations which ensure that the beams 12 are distributed substantially uniformly throughout the airplane 22, and which ensure that the beams 12 make substantially equal contact with the lower surfaces of the affected airplane floor structure 14. Gaps between the beams 12 and floor structure 14 may be shimmed prior to applying full load on the beams 12 to ensure substantially equal contact. Load cells may be connected to the support posts 32 to monitor load. Initially, a five-hundred pound load may be put on each support post 32 prior to proceeding to full load, which may be predetermined based on the support structure and load conditions. The load cells may be monitored to ensure that the maximum load for each support post 32 and/or location is not exceeded. The support posts 32 may support the beams 12 rested under the airplane's floor structure 14, and as a result, the support posts 32 may correspondingly support the floor structure 14 of the airplane 22 during the replacement of airplane parts.

The upper airplane parts, such as the airplane's upper skin panels and upper window assemblies, may then be removed and replaced with new parts. Upon completion, one or more beams 58 may be extended through one or more of the airplane's windows 60 through one or more of the airplane's other windows 62 located on an opposite side of the airplane 22. In one embodiment, the beams 58 may be installed through cabin windows located at BS 400, 500, 787, 800, and 900 per Boeing Procedure 737-300 SRM 51-50-02. In another embodiment, two beams 58 may be extended through windows forward of the wings, and another two beams 58 may be placed through windows aft of the wings. The beams 58 may be supported by one or more connected support structures 64, such as support posts 64 bolted to the beams 58, which extend from the beams 58 to the ground surface 38. The connected support structures 64 may be attached to jacks 66 on the ground surface 38 to further jack up the airplane 22. The beams 58 may be distributed throughout forward 20 and aft 28 portions of the airplane 22. In other embodiments, any number of varied material beams 58 may be used in differing shapes, sizes, locations, orientations, and configurations. The beams 58 may aid in supporting the airplane 22 as dictated by procedures in Boeing's Structural Repair Manual (SRM). Load cells may be used to distribute weight substantially appropriately throughout the beams 58 and/or support structures 64. A load of between 500 pounds to 1,500 pounds may be applied on the beams 58 at each window location.

After the beams 58 are fully loaded, the jacks 16 may be lowered to remove the support posts 32 from the holes 34 in the airplane's lower skin 36. The beams 12 may then be disassembled and removed from the airplane's cargo bay. During this process, the load cells connected to the beams 58 and/or support structures 64 may be monitored to ensure that the maximum allowable load is not exceeded. The lower airplane parts, such as the airplane's lower skin panels, may then be removed and replaced with new parts. After the lower airplane parts are replaced, the cradles 48 may be removed from their positions against the airplane 22. The loads on the window beams 58 and body fittings 40 may be monitored using the load cells to ensure that the maximum loads are not exceeded. The window beams 58, body fittings 40, and jacks 66 may then be removed from the airplane 22. The airplane 22 may then be jacked down to the ground utilizing jacks 74 to complete the replacement procedure.

The invention may make the process of repairing and/or replacing parts on an airplane less difficult, more efficient, less timely, and/or less costly. The invention may allow airplane parts above the floor level to be repaired and/or replaced simultaneously as airplane parts below the floor level. Other problems associated with the replacement of airplane parts may also be lessened.

It should be understood, of course, that the foregoing relates to exemplary embodiments of the invention and that modifications may be made without departing from the spirit and scope of the invention as set forth in the following claims.

We claim:

1. A method of shoring an airplane to facilitate the replacement of one or more airplane parts, the method comprising:
disposing at least one beam underneath an airplane floor structure;
supporting said at least one beam with at least one jack, wherein at least a portion of said at least one jack extends through at least one hole in a lower skin of the airplane;
removing at least one airplane part; and
replacing said at least one airplane part.

2. The method of claim 1, wherein the step of disposing at least one beam underneath an airplane floor structure comprises disposing first and second beams underneath a forward portion of said airplane, and disposing third and fourth beams underneath an aft portion of said airplane.

3. The method of claim 1, wherein said at least one beam comprises a plurality of connected beam segments.

4. The method of claim 3, wherein said plurality of beam segments are connected together by bolts.

5. The method of claim 1, wherein said at least one beam abuts against at least a portion of said airplane floor structure.

6. The method of claim 1, wherein said portion of said at least one jack comprises at least one support post.

7. The method of claim 2, wherein each of said first, second, third, and fourth beams are supported by two or more support posts.

8. The method of claim 1, wherein said at least one beam is made at least partially of at least one of aluminum and steel.

9. The method of claim 1, further comprising the step of jacking up the airplane away from a ground surface using said at least one jack.

10. The method of claim 1, further comprising the step of attaching at least one body fitting to an outer surface of the airplane.

11. The method of claim 10, wherein a plurality of body fittings are bolted to a forward portion of the airplane and a plurality of body fittings are bolted to an aft portion of the airplane.

12. The method of claim 10, wherein said at least one body fitting is attached to at least one jack including at least one support post.

13. The method of claim 12, further comprising the step of jacking up away from a ground surface said at least one body fitting.

14. The method of claim 1, further comprising the step of disposing at least one cradle against the airplane.

15. The method of claim 14, further comprising the step of jacking up said at least one cradle away from a ground surface.

16. The method of claim 14, wherein the step of disposing said at least one cradle against the airplane comprises disposing at least one cradle against a fuselage of the airplane and disposing at least one cradle against a wing of the airplane.

17. The method of claim 1, further comprising the step of cutting said at least one hole in said lower skin of said airplane.

18. The method of claim 1, wherein the steps of removing and replacing said at least one airplane part comprises removing and replacing at least one of an upper skin panel, a lower skin panel, and a window assembly.

19. The method of claim 1, further comprising the step of extending at least one beam from one airplane window to another airplane window.

20. The method of claim 19, wherein the step of removing and replacing said at least one airplane part comprises removing and replacing a lower skin panel after completing the step of extending said at least one beam from said one airplane window to said another airplane window.

21. The method of claim 14, further comprising the step of removing said at least one cradle from against the airplane after completing the step of replacing said at least one airplane part.

22. The method of claim 1, further comprising the step of removing said at least one beam from said at least one airplane floor structure after completing the step of replacing said at least one airplane part.

23. The method of claim 10, further comprising the step of removing said at least one body fitting from the airplane after completing the step of replacing said at least one airplane part.

24. The method of claim 19, further comprising the step of removing said at least one beam from said windows after completing the step of replacing said at least one airplane part.

25. The method of claim 9, further comprising the step of jacking down said airplane toward said ground surface after completing the step of replacing said at least one airplane part.

26. The method of claim 1, wherein said at least one beam is disposed substantially parallel to said airplane floor structure.

27. An airplane comprising:
at least one replaced airplane part, wherein said at least one airplane part was replaced while at least one beam was temporarily disposed underneath an airplane floor structure, said at least one beam having been supported by at least one jack which extended through at least one hole in a lower skin of the airplane.

28. The airplane of claim 27, wherein said at least one airplane part was replaced while said at least one beam was at least one of abutted and attached to said airplane floor structure.

29. The airplane of claim 27, wherein said at least one airplane part was replaced while at least one body fitting was attached to the airplane.

30. The airplane of claim 27, wherein said at least one airplane part was replaced while at least one cradle was disposed against the airplane.

31. The airplane of claim 27, wherein said at least one airplane part was replaced while at least one beam was extended from one airplane window to another airplane window.

32. The airplane of claim 27, wherein said at least one replaced airplane part comprises at least one of an upper skin panel, a lower skin panel, and a window assembly.

33. The airplane of claim 27, wherein said at least one jack comprises at least one support post.

34. An apparatus shoring an airplane to facilitate the replacement of one or more airplane parts, the apparatus comprising:
at least one beam disposed underneath an airplane floor structure; and
at least one jack supporting said at least one beam, wherein at least a portion of said at least one jack extends through at least one hole in a lower skin of the airplane.

35. The apparatus of claim 34, wherein said at least one beam is at least one of abutted and attached to said airplane floor structure.

36. The apparatus of claim 34, wherein the apparatus further comprises at least one body fitting attached to the airplane.

37. The apparatus of claim 34, wherein the apparatus further comprises at least one cradle disposed against the airplane.

38. The apparatus of claim 34, wherein the apparatus further comprises at least one beam extended from one airplane window to another airplane window.

39. The apparatus of claim 34, wherein said one or more airplane parts comprise at least one of an upper skin panel, a lower skin panel, and a window assembly.

40. The airplane of claim 34, wherein said at least one jack comprises at least one support post.
